(19) United States
(12) Patent Application Publication
(10) Pub. No.: US 2023/0282137 A1
(43) Pub. Date: Sep. 7, 2023

(54) AUXILIARY PRESCRIPTION LABEL

(71) Applicant: En-Vision America, Inc., Palmetto, FL (US)

(72) Inventors: David Raistrick, Bradenton, FL (US); Craig Raistrick, Bradenton, FL (US)

(21) Appl. No.: 18/176,244

(22) Filed: Feb. 28, 2023

Related U.S. Application Data
(60) Provisional application No. 63/268,718, filed on Mar. 1, 2022.

(51) Int. Cl. G09F 3/02; G09F 3/10

(52) U.S. Cl. CPC G09F 3/02883; G09F 3/02; G09F 3/10; G09F 2003/0202; G09F 2003/0222; G09F 2003/0239; G09F 2003/0241; G09F 2003/0269; G09F 2003/0273

(57) ABSTRACT

An auxiliary prescription label for a prescription receptacle which is used in combination with a primary prescription label is provided. The prescription label includes at least a first panel and a second panel which are foldably connected together. First and second flaps extend from opposite sides of the first panel. A permanent adhesive is provided on a first face of the first flap, and a releasable adhesive on a first face of the second flap. The permanent adhesive and the releasable adhesive are configured to be secured to the prescription receptacle. A method of adhering the auxiliary label to the prescription receptacle is also provided.

### CROSS-REFERENCE TO RELATED APPLICATION(S)

This application claims priority to U.S. provisional application Serial No. 63/268,718 filed Mar. 1, 2022, the contents of which are incorporated herein in its entirety.

### FIELD OF THE INVENTION

The present invention relates to an auxiliary prescription label which is printable at the pharmacy and can be easily applied to a prescription bottle having a primary prescription label.

### BACKGROUND OF THE INVENTION

A prescription label contains vital information about a medication. Placing full pertinent prescription labeling information onto medications is a critical part of a pharmacist’s job. Many pharmacies are being forced to comply with State laws that mandate printing and affixing a label with dual languages contained on them (for example, Spanish and English). Without enough space on their current prescription label, pharmacies are in need of a solution.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 is a side elevation view of a prescription receptacle having a primary standard prescription label and an auxiliary prescription label which is formed in accordance with a first embodiment of the present disclosure;

FIG. 2 is a cross-sectional view along line 2-2 of FIG. 1;

FIG. 3 is a cross-sectional view along line 3-3 of FIG. 1;

FIG. 4 is a side elevation view of the prescription receptacle showing the auxiliary prescription label in an unfurled and unfolded position;

FIG. 5 is a perspective view of a continuous roll of sheet material used form the auxiliary prescription label;

FIG. 6 is a top plan view of a portion of the roll of FIG. 5 shown laid flat;

FIGS. 7-9 are top plan views showing the steps used to form the auxiliary prescription label of FIG. 1;

FIG. 10 is a side elevation view of a prescription receptacle having a primary standard prescription label and an auxiliary prescription label which is formed in accordance with a second embodiment of the present disclosure;

FIG. 11 is a cross-sectional view along line 11-11 of FIG. 10;

FIG. 12 is a side elevation view of the prescription receptacle showing the auxiliary prescription label in an unfurled position;

FIG. 13 is a perspective view of a continuous roll of sheet material used form the auxiliary prescription label;

FIG. 14 is a top plan view of a portion of the roll of FIG. 13 shown laid flat; and

FIGS. 15-17 are bottom plan views of an individual label shown in an unfolded position.

### DETAILED DESCRIPTION OF THE ILLUSTRATED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein. Therefore, unless otherwise noted, features disclosed herein may be combined together to form additional combinations that were not otherwise shown for purposes of brevity.

A prescription receptacle 20 has a primary standard prescription label 22 attached thereto, and an auxiliary prescription label 24, 124 attached thereto. The auxiliary prescription label 24, 124 partially overlays the primary standard prescription label 22, but can be easily removed from the primary standard prescription label 22 so that the primary standard prescription label 22 can be accessed and read. The auxiliary prescription label 24, 124 may have dual languages, as is required in many States, and may have large print (minimum of 18 point font) thereon.

The prescription receptacle 20 can take many forms, for example but not limited to, vials, bottles and boxes. The prescription receptacle 20 has an open-ended body 26 which is closed by a removable lid or cap 28. As shown in the drawings, the prescription receptacle 20 is a bottle. The body 26 has a cylindrical side wall with an open upper end, and a bottom wall closing the lower end of the side wall. The removable lid or cap 28 is attached to the side wall for closing the upper open end.

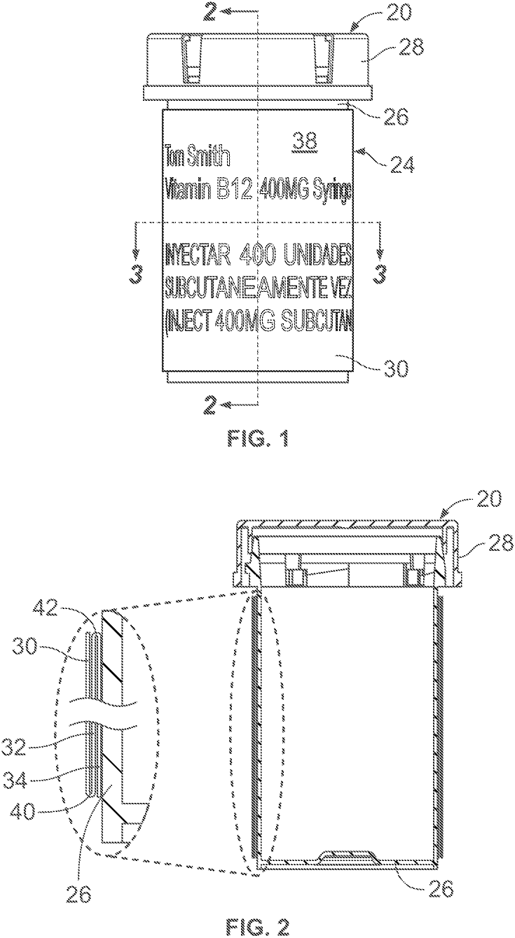

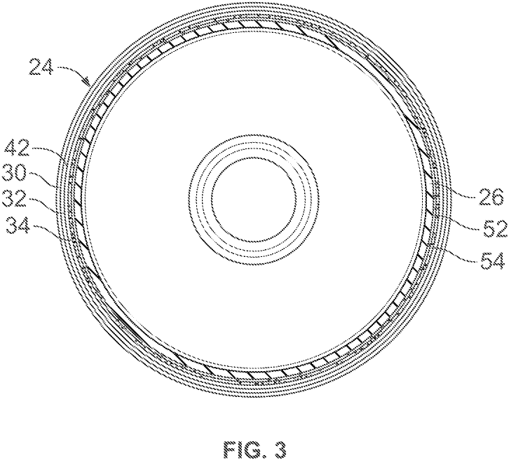

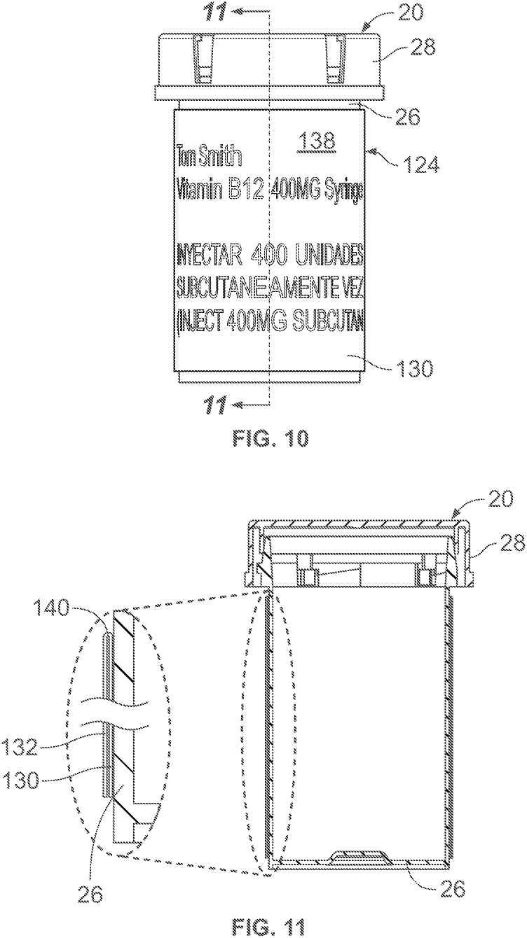

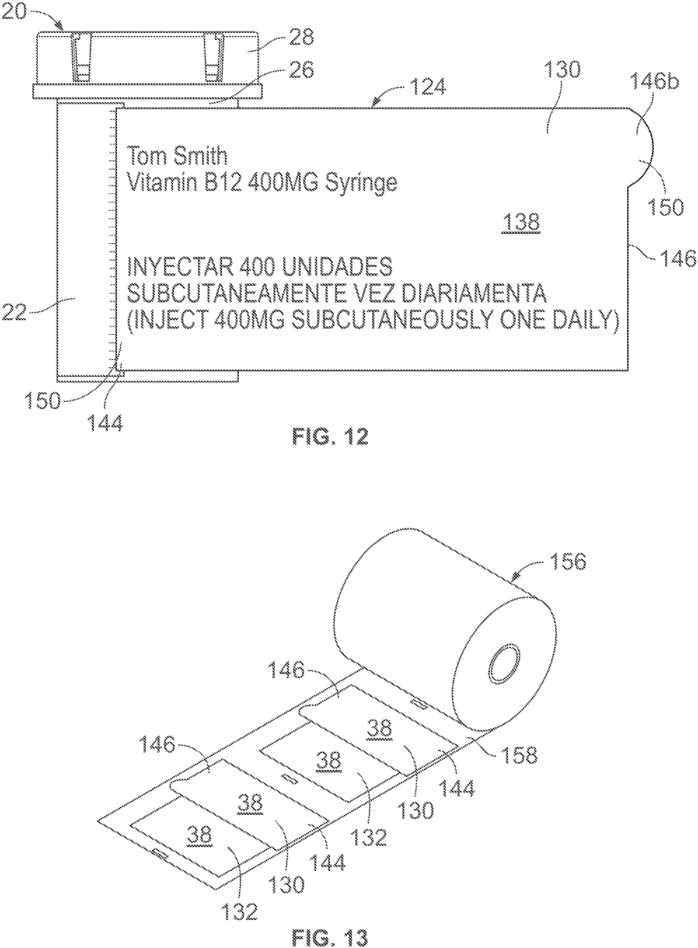

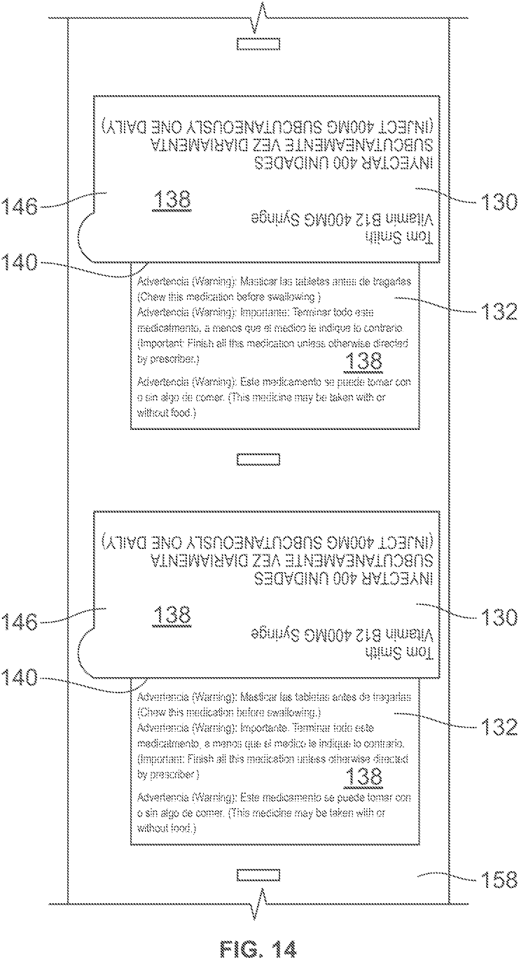

A first embodiment of the auxiliary prescription label 24 is shown in FIGS. 1-9. A second embodiment of the auxiliary prescription label 24 is shown in FIGS. 10-17.

Attention is invited to the first embodiment of the auxiliary prescription label 24 which is shown in FIGS. 1-9. The auxiliary prescription label 24 includes at least two panels. As shown, three panels 30, 32, 34 are provided. Each panel 30, 32, 34 has a first face 36 and a second, opposite face 38 and is defined by a first end, an opposite second end, and opposite side edges between the first and second ends. The second face 38 of each panel 30, 32, 34 can be printed upon. The panels 30, 32, 34 are formed of materials which can be fed through a printer and printed upon, such as paper or polypropylene. The second printable face 38 of each panel 30, 32, 34 may have a direct thermal coating for it to be printable by a direct thermal printer or thermal transfer coating that allows for it to be printable by a thermal transfer printer. In the embodiment as shown, the first panel 30 is foldably connected to the second, intermediate panel 32 at a line 40 formed between the second end of the first panel 30 and the first end of the second panel 32, and the third panel 34 is foldably connected to the second panel 32 at a line 42 formed between the second end of the second panel 32 and the first end of the third panel 34. The lines 40, 42 may be formed by perforations or by a fold. The first end of the first panel 30 is free, and the second end of the third panel 34 is free. Each panel 30, 32, 34 may have the same length and width, and each has the same thickness. A first flap 44 extends outward from the first side edge of the first panel 30 and is integrally formed therewith, and a second flap 46 extends outward from the second side edge of the first panel 30 and is integrally formed therewith. Each flap 44, 46 has a first face 48 which is coplanar with the first face 36 of the first panel 30, and an opposite second face 50 which is coplanar with the second printable face 38 of the first panel 30. The flaps 44, 46 may extend between the first and second ends of the first panel 30.

One flap, for example, the first flap 44 has a permanent adhesive 52 on the first face 48 thereof, and the other flap, for example, the second flap 46 has a releasable adhesive 54 on the first face 48 thereof.

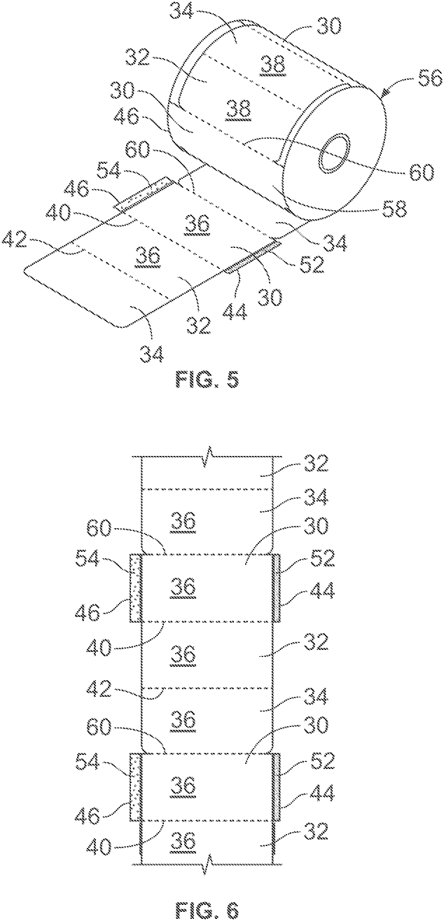

The auxiliary prescription label 24 may be formed from a continuous roll 56 of sheet material as shown in FIG. 5. The panels 30, 32, 34, which eventually form the individual auxiliary prescription labels 24, are on a removable release liner 58, and the first end of the first panel 30 of the auxiliary prescription label 24 is connected to the second end of the third panel 34 of what will become the next auxiliary prescription label at a line 60 formed therebetween, and this repeats for what will become the next auxiliary prescription label and so on in the roll 56. The adhesives 52, 54 contact the removable release liner 58, and are releasable therefrom. In FIG. 5, the removable release liner 58 is not shown on the panels 30, 32, 34 extending from the roll 56 so that the first faces 36 can be illustrated, The lines 60 may be formed by perforations or a fold. The roll 56 can be fed through a standard printer (not shown) so that prescription information is printed on the second faces 38 on demand and on site at a pharmacy. The prescription information can be printed in dual languages in order to comply with State laws. After the auxiliary prescription label 24 is printed at the pharmacy, the auxiliary prescription label 24 is severed at line 60 from the third panel 34 of what will become the next auxiliary prescription label. If the line 60 is formed by perforations, the auxiliary prescription label 24 can be severed from what will become the next auxiliary prescription label simply by tearing. If the line 60 is formed by a fold, the auxiliary prescription label 24 can be severed from what will become the next auxiliary prescription label by cutting.

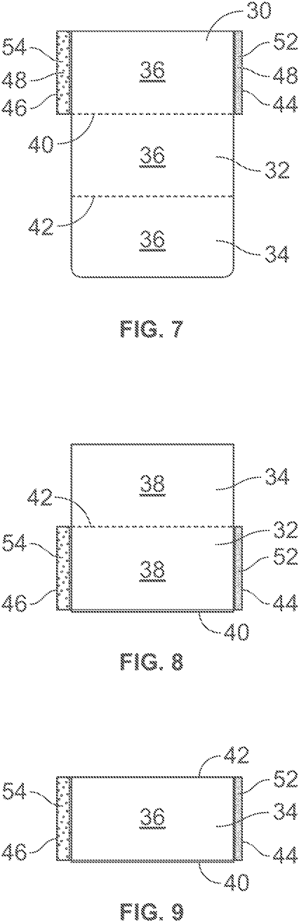

After being printed and severed, see FIG. 7, the auxiliary prescription label 24 is folded into shape. As shown in FIG. 8, the second panel 32 is folded relative to the first panel 30 at line 40 so that the first face 36 of the second panel 32 abuts against the first face 36 of the first panel 30. Thereafter, as shown in FIG. 9, the third panel 34 is folded relative to the second panel 32 at line 42 so that the second face 38 of the third panel 34 abuts against the second face 38 of the second panel 32. The panels 30, 32, 34 may have the same dimensions or different dimensions. When folded, the second and third panels 32, 34 do not overlap the permanent and releasable adhesives 52, 54. Alternatively, the third panel 34 can be folded relative to the second panel 32 at line 42, and then the second panel 32 folded relative to the first panel 30 at line 40.

To assemble the auxiliary prescription label 24 with the prescription receptacle 20, the liner on the permanent adhesive 52 is removed and the first panel 30 is permanently adhered to the body 26 of the prescription receptacle 20 using the permanent adhesive 52 in the desired location. The folded panels 30, 32, 34 and the second flap 46 are then wrapped around the body 26 of the prescription receptacle 20. This exposes the printing on the second printable face 38 of the first panel 30, and the folded-under second and third panels 32, 34 are trapped between the first panel 30 and the outer surface of the body 26 of the prescription receptacle 20. In the folding technique as described herein, the face 36 of the third panel 34 abuts against the body 26. Thereafter, the liner on the releasable adhesive 54 is removed and the first panel 30 is again adhered to the body 26 of the prescription receptacle 20 with the releasable adhesive 54. The folded panels 30, 32, 34 and the second flap 46 can be wrapped around the body 26 of the prescription receptacle 20 such that the releasable adhesive 54 on the second flap 46 is coupled to the body 26, is coupled to the primary prescription label 22, is coupled to the first flap 44, or is coupled to the first panel 30.

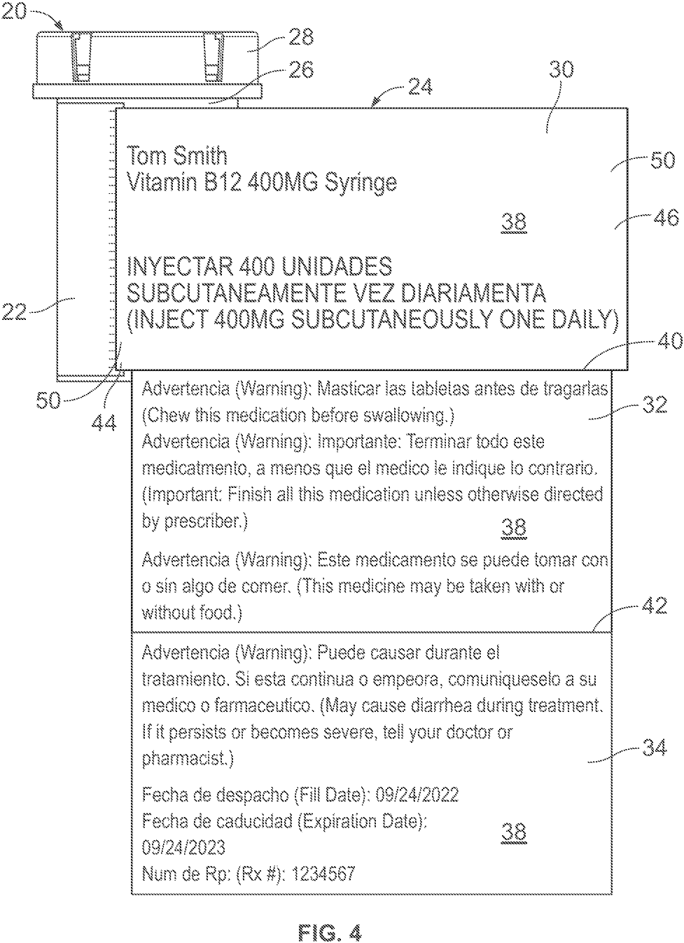

The consumer can release the auxiliary prescription label 24 from the prescription receptacle 20 by pulling the flap 46 with the releasable adhesive 54 away from the body 26 of the prescription receptacle 20 (or the auxiliary prescription label 24 if the auxiliary prescription label 24 overlaps itself). The consumer can then unfold the second and third panels 32, 34 to show the full prescription information, as shown in FIG. 4. The auxiliary prescription label 24 can be easily refolded, rewrapped around the body 26 and reattached using the releasable adhesive 54.

Since line 42 between the panels 32, 34 is formed from perforations in some embodiments, the user can easily tear off the third panel 34 if the third panel 34 is not desired in the final assembly. Likewise, since line 40 between the panels 30, 32 is formed from perforations in some embodiments, the user can easily tear off the second and third panels 32, 34 if the second and third panels 32, 34 are not desired in the final assembly.

Attention is invited to the second embodiment of the auxiliary prescription label 124 which is shown in FIGS. 1-9. The auxiliary prescription label 124 includes first and second panels 130, 132. Each panel 130, 132 has a first face 136 and a second, opposite face 138 and is defined by a first end, an opposite second end, and opposite side edges between the first and second ends. The second face 138 of each panel 130, 132 can be printed upon. The panels 130, 132 have the same dimensions. The panels 130, 132 are formed of materials which can be fed through a printer and printed upon, such as paper or polypropylene. The second printable face 138 of each panel 130, 132 may have a direct thermal coating for it to be printable by a direct thermal printer or thermal transfer coating that allows for it to be printable by a thermal transfer printer. The first panel 130 is foldably connected to the second panel 132 at a line 140 formed between the second end of the first panel 130 and the first end of the second panel 132. The line 140, 42 may be formed by perforations or by a fold. The first end of the first panel 130 is free, and the second end of the second panel 132 is free. Each panel 130, 132 may have the same length and width, and each has the same thickness. A first flap 144 extends outward from the first side edge of the first panel 130 and is integrally formed therewith, and a second flap 146 extends outward from the second side edge of the first panel 130 and is integrally formed therewith. Each flap 144, 146 has a first face 148 which is coplanar with the first face 136 of the first panel 130, and an opposite second face 150 which is coplanar with the second printable face 138 of the first panel 130. The flap 144 may extend between the first and second ends of the first panel 130. The flap 146 has a first portion 146a which extends between the first and second ends of the first panel 130, and a second portion 146b which extends outward from the first portion 146a. The second portion 146b has a length which is less than the first portion 146a and forms a finger tab. The first flap 144 has a permanent adhesive 152 on the first face 148 thereof.

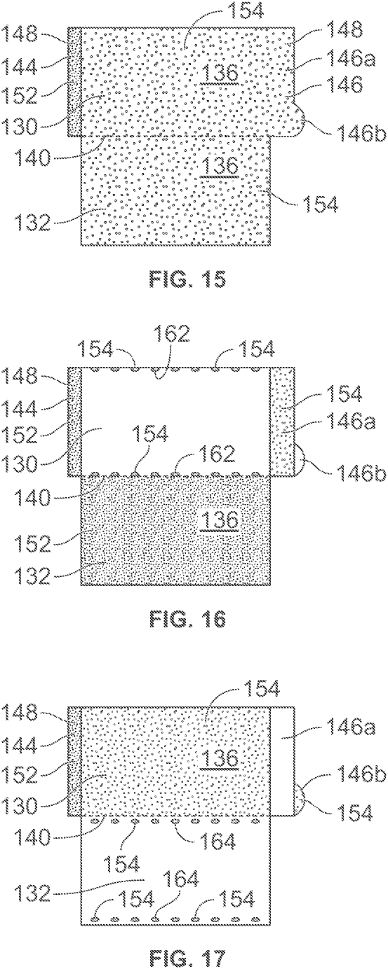

A first embodiment of the auxiliary prescription label 124 is shown in FIG. 15. The first face 136 of the first panel 130 and the flap 146 have a releasable adhesive 154 thereon. The first face 136 of the second panel 132 has a releasable adhesive 154 thereon.

A second embodiment of the auxiliary prescription label 124 is shown in FIG. 16. The first face 136 of the first panel 130 does not have an adhesive surface (either no adhesive may be provided, or any adhesive thereon may be chemically deadened), with the exception of spaced apart sections 162 which extend in lines parallel to the line 140 along the ends of the panel 130 and are provided by releasable adhesive 154. The sections 162 may not be provided. The first face 136 of the second panel 132 has a permanent adhesive 152 thereon. The first face 148 of the first portion 146a of the second flap 146 has a releasable adhesive 154 thereon, and the second portion 146b of the second flap 146 does not have does not have an adhesive surface (either no adhesive may be provided, or any adhesive thereon may be chemically deadened).

A third embodiment of the auxiliary prescription label 124 is shown in FIG. 17. The first face 136 of the first panel 130 has a releasable adhesive 154 thereon. The first face 136 of the second panel 132 does not have adhesive surface (either no adhesive may be provided, or any adhesive thereon may be chemically deadened), with the exception of spaced apart sections 164 which extend in lines parallel to the line 140 along the ends of the panel 132 and are provided by releasable adhesive 154. The sections 164 may not be provided. The first face 148 of the first portion 146a of the second flap 146 does not have adhesive surface (either no adhesive may be provided, or any adhesive thereon may be chemically deadened), and the first face 148 of the second portion 146b of the second flap 146 has a releasable adhesive 154 thereon.

The auxiliary prescription label 124 may be formed from a continuous roll 156 of sheet material as shown in FIG. 13. The panels 130, 132, which eventually form the individual auxiliary prescription labels 124, are on a removable release liner 158. The adhesives 152, 154 contact the removable release liner 158, and are releasable therefrom. The roll 156 can be fed through a standard printer (not shown) so that prescription information is printed on the second faces 138 on demand and on site at a pharmacy. The prescription information can be printed in dual languages in order to comply with State laws. After the auxiliary prescription label 124 is printed at the pharmacy, the auxiliary prescription label 124 pulled off of the release line 158.

After being printed and removed from the release line 158, the auxiliary prescription label 124 is folded into shape. The second panel 132 is folded relative to the first panel 130 at line 140 so that the first face 136 of the second panel 132 abuts against the first face 136 of the first panel 130.

In the embodiment shown in FIG. 15, the releasable adhesive 154 on the first face 136 of the first panel 130 and on the first face 136 of the second panel 132 adhere together to form a permanent bond. The permanent adhesive 152 on the first flap 144 and the releasable adhesive 154 on the second flap 146 remain uncovered.

In the embodiment shown in FIG. 16, the permanent adhesive 152 on the first face 136 of the second panel 132 and the first face 136 of the first panel 130 adhere together to form a permanent bond. The permanent adhesive 152 on the first flap 144 and the releasable adhesive 154 on the second flap 146 remain uncovered. While the permanent adhesive 152 is provided on the first face 136 of the second panel 132 and an adhesive surface is not provided on the first face 136 of the first panel 130 (except sections 164 may be provided), the permanent adhesive 152 may instead be provided on the first face 136 of the first panel 130 and an adhesive surface is not provided on the first face 136 of the second panel 132 (except sections 164 may be provided).

In the embodiment shown in FIG. 17, the releasable adhesive 154 on the first face 136 of the first panel 130 and the first face 136 of the second panel 132 adhere together to form a releasable bond. If the sections 164 are provided, when the sections 164 come into contact with the releasable adhesive 154 on the first face 136 of the first panel 130, the sections 164 and the releasable adhesive 154 on the first face 136 of the first panel 130 permanently bond together. The permanent adhesive 152 on the first flap 144 and the releasable adhesive 154 on the second flap 146 remain uncovered. While the releasable adhesive 154 is provided on the first face 136 of the first panel 130 and an adhesive surface is not provided on the first face 136 of the second panel 132 (except sections 164 may be provided), the releasable adhesive 154 may instead be provided on the first face 136 of the second panel 132 and an adhesive surface is not provided on the first face 136 of the first panel 130 (except sections 164 may be provided).

To assemble the auxiliary prescription label 124 with the prescription receptacle 20, the first panel 130 is permanently adhered to the body 26 of the prescription receptacle 20 using the permanent adhesive 152 on the flap 144. The folded panels 130, 132 and the second flap 146 are then wrapped around the body 26 of the prescription receptacle 20. This exposes the printing on the second printable face 138 of the first panel 130, and the folded second panel 132 is trapped between the first panel 130 and the outer surface of the body 26 of the prescription receptacle 20. The second face 138 of the second panel 132 abuts against the body 26. The releasable adhesive 154 on the second face 138 of the first panel 130 is adhered to the body 26 of the prescription receptacle 20. The folded panels 130, 132 and the second flap 146 can be wrapped around the body 26 of the prescription receptacle 20 such that the releasable adhesive 154 on the second flap 146 is coupled to the body 26, is coupled to the primary prescription label 22, is coupled to the first flap 144, or is coupled to the first panel 130.

The consumer can release the auxiliary prescription label 124 from the prescription receptacle 20 by pulling the flap 146 (which can be grasped by the second section 146b) away from the body 26 of the prescription receptacle 20 (or the auxiliary prescription label 124 if the auxiliary prescription label 124 overlaps itself). The consumer can then view the printed material on the second face 138 of the second panel 132. The auxiliary prescription label 124 can be easily rewrapped around the body 26 and reattached using the releasable adhesive 154.

Since line 140 between the panels 130, 132 is formed from perforations in some embodiments, the user can easily tear off the second panel 132 if the second panel 132 is not desired in the final assembly.

The auxiliary prescription label 24, 124 is assembled to the prescription receptacle 20 in such a manner that the primary standard prescription label 22 is not permanently obscured. The auxiliary prescription label 24, 124 can partially or fully overlay the primary standard prescription label 22, but the auxiliary prescription label 24, 124 can be lifted away from the primary standard prescription label 22 so that the primary standard prescription label 22 can be read. The auxiliary prescription label 24, 124 is easy-to-use and inexpensive for a pharmacy to print and use. The second face 138 of the first panel 130 remains prominent and freely readable. The auxiliary prescription label 24, 124 maintains the integrity and readability of the legal, state-regulated primary standard prescription label 22 that pharmacies place on medications.

The auxiliary prescription label 24, 124 provides additional several advantages. The auxiliary prescription label 24, 124 can be printed with 100% variable data and placed on the prescription receptacle 20 at the time the medication is repackaged into smaller prescription receptacles 20 at the pharmacy. The auxiliary prescription label 24, 124 can be printed using a typical desktop direct-thermal printer. By using the permanent adhesive 52, 152 on one flap 44, 144 and the releasable adhesive 54, 154 on the other flap 46, an uncomplicated design is achieved. Finally, there is no need for additional clips or attachments to affix the label to the prescription receptacle 20.

While preferred embodiments of the present invention are shown and described, it is envisioned that those skilled in the art may devise various modifications of the present invention without departing from the spirit and scope of the appended claims.

What is claimed is:

1. A label for a prescription receptacle comprising:
at least a first panel and a second panel which are foldably connected together, each panel having a first face and a second printable face;
a first flap extending outward from a first side of the first panel, and a second flap extending outward from a second, opposite side of the first panel, the flaps having first faces which are continuous with the first face of the first panel and second faces which are continuous with the second face of the first panel;
a permanent adhesive on the first face of the first flap; and
a releasable adhesive on the first face of the second flap,
wherein each of the permanent adhesive and the releasable adhesive are configured to be secured to the prescription receptacle.

2. The label as defined in claim 1, wherein at least one of the first faces of the first and second panels have adhesive thereon.

3. The label as defined in claim 2, wherein the adhesive on the one of the first faces is a permanent adhesive.

4. The label as defined in claim 2, wherein the adhesive on the one of the first faces is a releasable adhesive.

5. The label as defined in claim 1, wherein the first face of each of the first and second panels has a releasable adhesive thereon.

6. The label as defined in claim 1, wherein the first face of one of first and second panels has a permanent adhesive thereon, and the first face of the other one of first and second panels does not have an adhesive surface on the first face thereof.

7. The label as defined in claim 1, wherein the first face of one of first and second panels has a releasable adhesive thereon, and the first face of the other one of first and second panels does not have an adhesive surface on the first face thereof.

8. The label as defined in claim 1, wherein the second flap includes a portion which extends from the first panel and a finger tab extending from the portion, the finger tab having a length which is different than the portion.

9. The label as defined in claim 8, wherein the finger tab has releasable adhesive thereon.

10. The label as defined in claim 9, wherein the portion does not have an adhesive surface.

11. The label as defined in claim 1, wherein the panels are flaps are formed of a material having a direct thermal coating or a thermal transfer coating thereon.

12. The label as defined in claim 1, wherein the first and second panels are foldably connected together around a perforation line.

13. The label as defined in claim 1, wherein the first faces of the first and second panels do not have an adhesive surface thereof.

14. The label as defined in claim 13, further comprising a third panel foldable coupled to the second panel, the third panel having a first face and a second printable face, wherein the first face of the third panel does not have an adhesive surface thereof.

15. A prescription receptacle comprising:
a body;
a primary prescription label on the body; and
an auxiliary prescription label including
at least a first panel and a second panel which are foldably connected together, each panel having a first face and a second printable face;
a first flap extending outward from a first side of the first panel, and a second flap extending outward from a second, opposite side of the first panel, the flaps having first faces which are continuous with the first face of the first panel and second faces which are continuous with the second face of the first panel;
a permanent adhesive on the first face of the first flap; and
a releasable adhesive on the first face of the second flap,
wherein the permanent adhesive is secured to one of the body and the primary prescription label, and the releasable adhesive is secured to one of the body, the primary prescription label, the first flap and the first panel.

16. The prescription receptacle as defined in claim 15, wherein at least one of the first faces of the first and second panels have adhesive thereon.

17. The prescription receptacle as defined in claim 16, wherein the adhesive is one of a permanent adhesive and a releasable adhesive.

18. The prescription receptacle as defined in claim 15, wherein the first face of each of the first and second panels has a releasable adhesive thereon.

19. The prescription receptacle as defined in claim 15, wherein the first face of one of first and second panels has a permanent adhesive thereon, and the first face of the other one of first and second panels does not have an adhesive surface on the first face thereof.

20. The prescription receptacle as defined in claim 15, wherein the first face of one of first and second panels has a releasable adhesive thereon, and the first face of the other one of first and second panels does not have an adhesive surface on the first face thereof.

21. A method of labeling a prescription receptacle comprising:
printing information on a printable face of a label, the label including at least a first panel and a second panel, a first flap extending outward from a first side of the first panel, and a second flap extending outward from a second, opposite side of the first panel, the flaps having first faces which are continuous with the first face of the first panel and second faces which are continuous with the second face of the first panel, a permanent adhesive on the first face of the first flap, and a releasable adhesive on the first face of the second flap;
removing the printed on label from a release liner;
folding the first panel relative to the second panel without covering the permanent adhesive, the releasable adhesive and the printable face;
adhering the permanent adhesive to one of a body of the prescription receptacle and the primary prescription label on the body;
wrapping the folded panels around the body; and
adhering the releasable adhesive to one of the body, the primary prescription label, the first flap and the first panel.

22. The method of claim 21, wherein the printing is performed on demand.
